(19) United States
(12) Patent Application Publication
(10) Pub. No.: US 2018/0232442 A1
(43) Pub. Date: Aug. 16, 2018

(54) WEB API RECOMMENDATIONS

(71) Applicant: International Business Machines Corporation, Armonk, NY (US)

(72) Inventors: Evelyn Duesterwald, Millwood, NY (US); Wei Tan, Elmsford, NY (US); John E. Wittern, New York, NY (US)

(21) Appl. No.: 15/434,793

(22) Filed: Feb. 16, 2017

(51) Int. Cl. G06F 17/30

(52) U.S. Cl. CPC G06F 17/30705; G06F 17/30696; G06F 17/30011

(57) ABSTRACT

A Web application programming interfaces (API) recommendations technology for use in existing context (e.g., considering an already selected API) is disclosed. For example, recommendations for a “next” API, considering already “selected” APIs can be provided. Web API co-occurrence documents are derived for each Web API, based on modeling and previous usages with other web APIs. Web API co-occurrence topics and features are derived from the co-occurrence documents. Web APIs used together frequently can be considered as belonging to the same co-occurrence topic. Content about Web APIs can be associated with topics for later feature extraction. Features that can be extracted include: importance of topics, representative Web APIs in a topic (without being subject to bias due to frequent compositions in one topic), and descriptive words for a topic (if content about Web APIs was associated with topics). Patterns and recommendation are viewed, for a given Web API or a set of Web APIs, by calculating the expected co-occurrence with other Web APIs. Expected co-occurrences can be used to rank Web APIs for recommendation.

### BACKGROUND

The present invention generally relates to recommending Web application programming interfaces (API) and more specifically to recommending a “next” Web API considering already selected Web APIs.

### SUMMARY

One embodiment of the present invention is a computer-implemented method of recommending an application programming interface (API) includes: gathering Web API data and usage data; generating co-occurrence documents from the Web API data and usage data; deriving service co-occurrence topic and features from the co-occurrence topics; and generating a list of recommended Web APIs for use with the Web APIs.

Other embodiments include a computer program product and a system.

### BRIEF DESCRIPTION OF THE DRAWINGS

Additional objects, features, and advantages of the present disclosure will become more clearly apparent when the following description is taken in conjunction with the accompanying drawings, in which:

FIG. 1 depicts an exemplary computer-implemented method in accordance with the present invention.

FIG. 2 is a schematic block diagram illustrating the components in the elements in the embodiment shown in FIG. 1.

FIG. 3 depicts an exemplary system in accordance with embodiments of the present invention.

### DETAILED DESCRIPTION OF PREFERRED EMBODIMENTS

By way of overview, an application programming interface (API) is a set of routines, protocols, and tools for building software applications. An API makes it easier for software developers to develop a software application by providing basic building blocks. These basic building blocks provide functions and sets of attributes associated with those functions including behavior and execution of those functions. A software developer then puts the basic building blocks together to create the software application. In essence, a software application's API defines a proper way for the software developer to request services from that software application. A world-wide web (“Web”) API makes these services available through the Web to a potentially large set of consuming applications.

Web APIs may be used for accessing a Web-based software service. Multiple Web APIs may be composed to accomplish a function unbeknownst to an end user. For example, when an end user buys movie tickets online and enters credit card information, the movie ticket Web site uses a Web API to send the credit card information to a remote software application that verifies whether the credit card information is correct. Once payment is confirmed, the remote software application sends a response back to the movie ticket Web site indicating that the move ticket Web site may issue the tickets to the end user. The end user only sees the movie ticket Web site interface, but behind the scenes many software applications are working together using different Web APIs to provide the Web-based software service. Thus, Web-based software service applications may be based on many different Web APIs from multiple sources.

Some aspects of the invention use a probabilistic topic model to reveal latent composition patterns of Web APIs. Discovered topics can be characterized as a multinominal distribution over Web APIs. A latent topic model can thus reveal several features: importance of the topic (i.e., what are important composition patterns), important words in the topic (i.e., what are important APIs for a composition pattern), and transitive co-occurrences (i.e., while not directly used with an API “C”, API “A” may be typically combined with an API “B” which may be combined with API C).

Each of the foregoing features cannot be achieved using existing usage-based recommendation approaches. Existing usage-based solutions can rely on frequent pattern/item set mining, e.g., “API A has been used with API B some x times”, which makes item sets which tend to be deterministic (not probabilistic) and non-transitive.

Some embodiments analyze data on Web APIs, including their identifier and historic usages, using probabilistic topic modeling to derive latent Web API co-occurrences and recommend APIs to use together.

Some embodiments consider data on Web APIs, including past usages, in the generation of co-occurrence documents. If services co-occur repeatedly, including topic importance and representative Web APIs, the co-occurrence document can reflect this by means of a co-occurrence factor. Web API co-occurrence documents count the number of co-occurrences as co-occurrence factor. By way of example, using co-occurrence documents as input, some embodiments derive co-occurrence topics. Based on co-occurrence topics, some embodiments derive service co-occurrence topic features, including topic importance and representative Web APIs. Given one or a list of Web APIs, some embodiments recommend relevant Web APIs to use therewith.

In some embodiments content characterizing input Web APIs is input and associated with co-occurrence topics, such that derived co-occurrence topic features include descriptive words for a topic (if content about Web APIs was associated with topics).

Some embodiments of the invention recommend APIs to use in an existing context (e.g., considering already selected APIs).

Other existing solutions include: (i) interface matching where the data definitions of an API (input and output) are input and a resulting recommendation is based on the question if output of API A can be input of API B, using syntactic (keyword matching) and semantic (based on ontology) approaches; AI planning and work-based solutions that recommend a composite service, also known as workflow; and content-based solutions e.g., where the input is (natural language) service descriptions, and matching includes both syntactic keyword matching and semantic matching based on an ontology.

In contrast, embodiments of the present invention use a probabilistic topic model to reveal the latent composition patterns of web APIs. Discovered topics are characterized as multinominal distribution over web APIs. A latent topic model can thus reveal: importance of the topic (i.e., what are important composition patterns), important words in the topic (i.e., what are important APIs for a composition pattern), transitive co-occurrences (i.e., while not directly used with API C, API A may be typically combined with API B which may be combined with API C), and (words extracted from what content describing APIs to characterize topics). These items cannot be achieved using existing usage-based recommendation approaches.

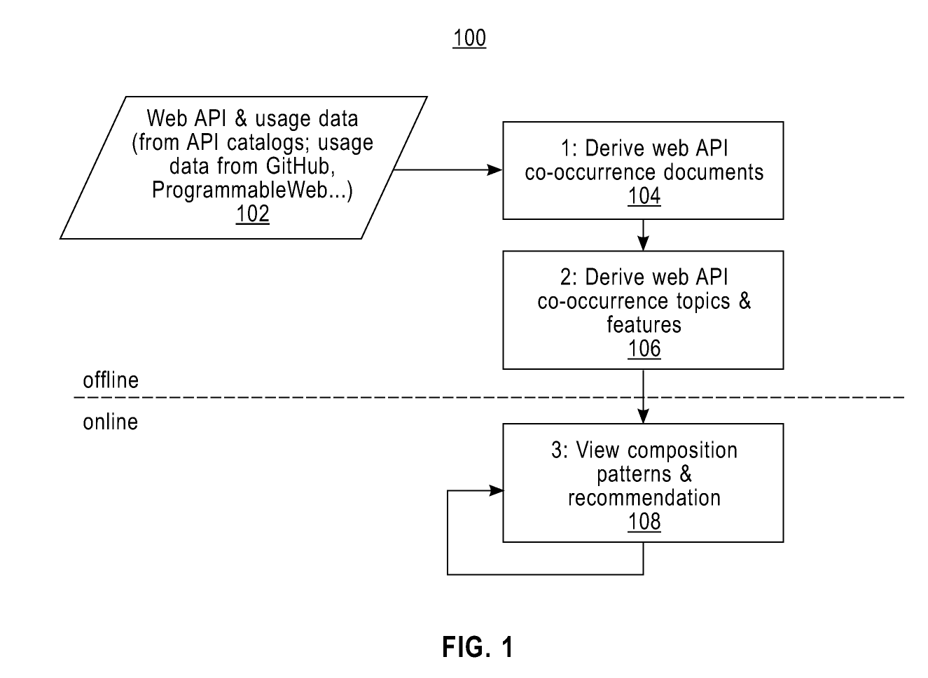

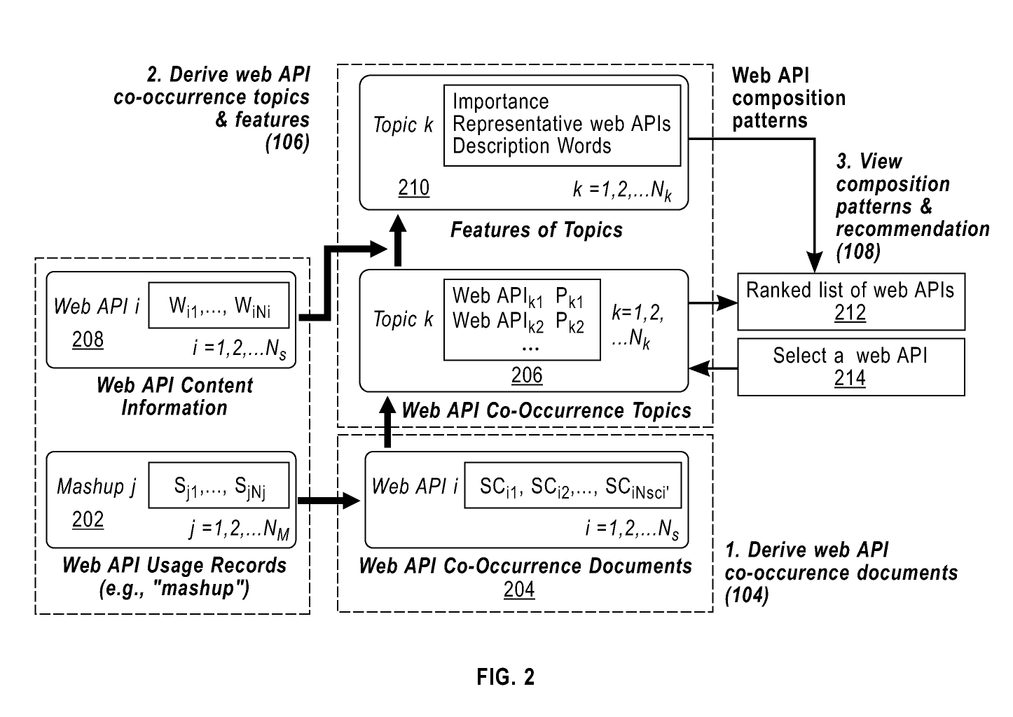

FIG. 1 depicts an exemplary method in accordance with the present invention. As depicted, in step 102 (offline mode), Web API and usage data are collected provided as input step 104. By way of a (non-limiting) example, Web API and usage data can be obtained from API catalogs, such as ProgrammableWeb; and usage data obtained from source code repositories such as GitHub, etc. In step 104, provided Web API and usage data is used to derive one or more web API co-occurrence documents. In step 106, the input data and derived (an example of which is described in more detail below with reference to FIG. 2), co-occurrence documents are used to derive one or more web API co-occurrence topics and features.

In step 108 (online mode), the derived web API co-occurrence topics and features are used to view composition patterns and make recommendations e.g., to an end user via their device.

FIG. 2 depicts a more detailed example of the example depicted in FIG. 1.

As shown, Web API usage records (e.g., “mashup j”) in block 202, where Sⱼ₁, . . . , S_{jNM} depict usage records provided as input to Web API co-occurrence documents (block 204). For example, these can represent web API usage records for mashup j. By way of example, a mashup can be an application that uses a number of APIs. One usage record could be the source code of the application, which can be used to identify which APIs are used. Another usage record associated with mashup j may be a textual description, which mentions the APIs used. These usage records become input to create “web API co-occurrence documents” (in block 204). By way of further example, SCᵢ₁, . . . , SC_{iNsci} can represent “web API co-occurrence documents” for an API. These documents can contain all co-occurrences of API₁ with other APIs, which can be found across the “web API usage records” that involve API₁ For a given Web API or a set of Web APIs, the expected co-occurrence with other Web APIs can be calculated.

The Web API co-occurrence documents from block 204 are provided to Web API co-occurrence topics (block 206), where e.g., Web APIₖ₁ Pₖ₁ are “API co-occurrence topics”. This example utilizes the notion that APIs are related—i.e., are in the same “topic”—based on their co-occurrence documents. The topics (from block 206) along with (optionally) Web API content information (from block 208), where Wᵢ₁, . . . , W_{iNi}, are additional “web API content information” for an API, can be used to determine features of topics (in block 210). This information could be, for example, a textual description of an API. Some embodiments include such information, to recommend related APIs, in consideration of some context. For example, consider an application written in the travel domain. This information can be considered to recommend APIs that go along well with already selected APIs as evidence in the travel domain (e.g., existing travel mashups/apps) suggests. In other words, the topics and additional web API content information can be used (in block 210) to determine the features of topics, e.g., the importance of representative web APIs description words.

The output (of block 210) and the output of web API co-occurrence topics (block 206) can (in some embodiments) be provided to a user device (not depicted) as a ranked list of web APIs (in block 212). Expected co-occurrences can be used to rank Web APIs. In block 214 the user can select (through the user's device) a web API from the list provided and the selection is fed back to the web API co-occurrence topics (block 206).

With reference now also to FIG. 1, deriving web API co-occurrence documents (step 104) may also include modeling, for each web API, previous API usages with other web APIs, as web API co-occurrence documents. In some embodiments, the web API co-occurrence documents count the number of co-occurrences as a co-occurrence factor. For example:

Google Maps API = {
a. Twitter API: 1,
b. Facebook Graph API: 3,
c. ...
}

Some embodiments of deriving Web API co-occurrence topics and features (step 106 of FIG. 1) apply and extend the classical Latent Dirichlet Allocation (LDA) in a consideration of Web API co-occurrences. For example, Web APIs used together a lot can be considered as belonging to the same (latent) co-occurrence topic. Some embodiments further allow associating content about Web APIs with topics for later feature extraction. Parameter learning can be performed (e.g., collapsed Gibbs sampling) to make inferences with the modeling.

By way of example, the following features can be extracted: importance of topics, representative Web APIs in a topic (without being subject to bias due to frequent compositions in one topic), and descriptive words for a topic (if content about Web APIs was associated with topics).

Some embodiments of viewing composition patterns and recommendation (step 108 of FIG. 1) include, for a given Web API or a set of Web APIs, calculation of expected co-occurrence(s) with other Web APIs. In some embodiments, the expected co-occurrences can be used in a ranking of recommended Web APIs. In some embodiments, frequent co-occurrences for selected topics can be returned, even without provision of an initial Web API.

In summary, various existing embodiments show that frequent item set mining is deterministic, not probabilistic; is non-transitive. Frequent item set mining cannot reveal: importance of pattern, important services in the pattern, and transitive patterns. Topic model can reveal importance of the topic, important words (services) in the topic, and transitive co-occurrences.

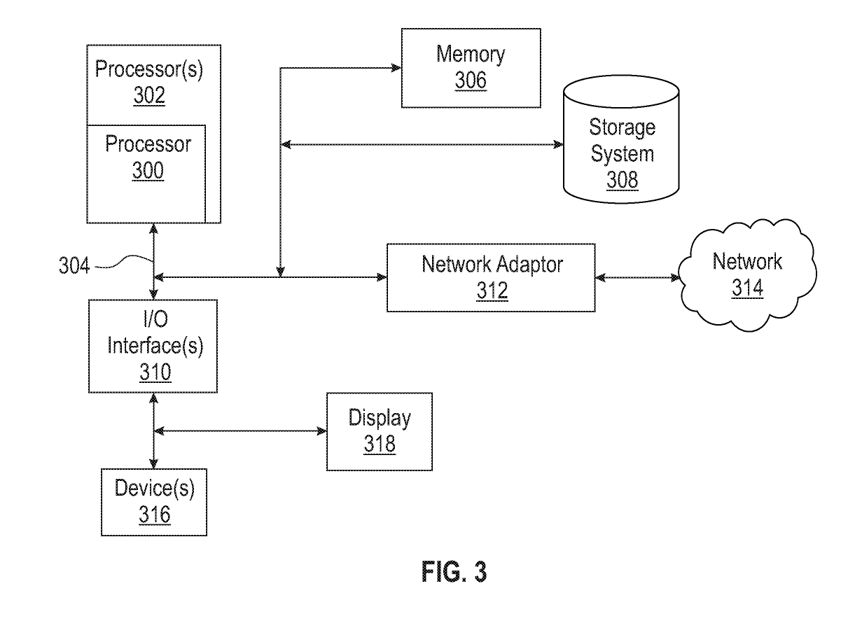

FIG. 3 illustrates an example system in accordance with the present invention. By way of overview and example only, some embodiments may recommend one or more Web application programming interfaces (API) and more specifically recommend one or more Web APIs for use in an existing context (e.g., considering an already selected API). The system depicted is only one example of a suitable system and is not intended to suggest any limitation as to the scope of use or functionality of embodiments of the invention. In contrast, the present invention may be operational with numerous other general purpose or special purpose computing systems, environments and/or configurations. A few examples of well-known computing systems, environments, and/or configurations that may be suitable for use with the system shown in FIG. 3 include (but are not limited to), personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The system of FIG. 3 may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

As depicted, the components of the system of FIG. 3 may include (but are not limited to), one or more processors or processing units 302, a system memory 306, and a bus 304 that operably couples various system components including system memory 306 to processor 302. The processor 302 may execute one or more modules 300 that performs methods in accordance with the present invention (e.g., described with reference to FIG. 1 and FIG. 2). The module 300 may be programmed into the integrated circuits of the processor 302, or loaded from memory 306, storage device 308, or network 314 or combinations thereof.

Bus 304 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 306 can include computer system readable media in the form of volatile memory, such as random access memory (RAM) and/or cache memory or others. Computer system may further include other removable/non-removable, volatile/non-volatile computer system storage media. By way of example only, storage system 308 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 304 by one or more data media interfaces.

Computer system may also communicate (via Input/Output (I/O) interfaces 310) with one or more external devices 316, such as a keyboard, a pointing device, a display 318, and/or one or more other devices that enable a user to interact/interface with the computer system; and/or any devices (e.g., network card, modem, network adaptor 312, etc.) that enable computer system to communicate with one or more other computing systems/devices. Such communication can occur via Input/Output (I/O) interfaces 310 and/or network adaptor 312.

By way of further example, the computer system of FIG. 3 can communicate with one or more networks 314, such as a local area network (LAN), a general wide area network (WAN), and/or a public network (e.g., the Internet) via network adapter 312. As depicted, network adapter 312 can also facilitate communication with other components of the computer system of FIG. 3 via bus 304. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. (canceled)

2. (canceled)

3. (canceled)

4. (canceled)

5. (canceled)

6. (canceled)

7. (canceled)

8. (canceled)

9. A computer program product for recommending an application programming interface (API), the computer program product comprising a computer readable storage medium having program instructions embodied therewith, wherein the computer readable storage medium is not a transitory signal per se, the program instructions executable by a computer to perform a method comprising:
gathering Web API (application programming interface) data and usage data;
generating one or more co-occurrence documents from the Web API data and usage data;
deriving one or more co-occurrence topics and features from the co-occurrence documents; and
generating a list of recommended Web APIs for use with the Web API.

10. The computer program product of claim 9, where the co-occurrence documents include a co-occurrence factor related to the services co-occurring repeatedly with API data and usage data.

11. The computer program product of claim 9, further comprising deriving service co-occurrence topics and features from the co-occurrence topics.

12. The computer program product of claim 9, wherein the co-occurrence topics features comprise topic importance and representative Web APIs.

13. The computer program of claim 9, further comprising retrieving and associating content with co-occurrence topics and extracting and including textual portions of associated content with co-occurrence topic features.

14. The computer program product of claim 9, further comprising inputting content characterizing input Web APIs and associating the input with co-occurrence topics whereby the derived service co-occurrence topic features include description words derived from the inputting content.

15. The computer program product of claim 9, where the list of recommended Web APIs is a ranked list.

16. A Web API (application programming interface) recommendation system comprising:
a processor;
a memory gathering and storing Web API (application programming interface) data and usage data;
a module generating one or more co-occurrence documents from the Web API data and usage data;
the module deriving one or more co-occurrence topics and features from the co-occurrence documents; and
the module generating a list of recommended Web APIs for use with the Web API.

17. The Web API recommendation system of claim 16, where the co-occurrence documents include a co-occurrence factor related to the services co-occurring repeatedly with API data and usage data.

18. The Web API recommendation system of claim 16, further comprising the module deriving service co-occurrence topics and features from the co-occurrence topics.

19. The Web API recommendation system of claim 16, wherein the list of recommended Web APIs is a ranked list.

20. The Web API recommendation system of claim 16, wherein the co-occurrence topics and features comprise topic importance and representative Web APIs.
